(19) United States
(12) Patent Application Publication
(10) Pub. No.: US 2016/0189856 A1
(43) Pub. Date: Jun. 30, 2016

(54) INTRINSICALLY SAFE TRANSFORMERS

(71) Applicant: Hubbell Incorporated, Shelton, CT (US)

(72) Inventors: Kashem Abul Sarder, Jesmond (AU); Peter Lim Sim Chan, West Pennant Hills (AU); Matthew John Chong, Baulkham Hills (AU)

(21) Appl. No.: 14/927,559

(22) Filed: Oct. 30, 2015

Related U.S. Application Data
(60) Provisional application No. 62/074,501, filed on Nov. 3, 2014.

(51) Int. Cl. H01F 27/32; H01F 27/24

(52) U.S. Cl. CPC H01F 27/325; H01F 27/24

(57) ABSTRACT

Intrinsically safe transformers and power supplies for use in hazardous environments are disclosed. The intrinsically safe transformers include a housing, a first winding associated with the housing, and a second winding associated with the housing where either the first or second winding or both windings are within an insulating jacket or sleeve to electrically isolate the windings.

### REFERENCE TO RELATED APPLICATIONS

This application claims priority to co-pending U.S. Provisional Application No. 62/074,501, filed on Nov. 3, 2014, entitled “Intrinsically Safe Transformers”, which is incorporated herein in its entirety by reference.

### BACKGROUND

1. Field

The present disclosure relates generally to transformers, and more particularly to intrinsically safe transformers for use in hazardous environments. The present disclosure also relates generally to intrinsically safe power supplies incorporating such intrinsically safe transformers.

2. Related Art

Hazardous environments, such as underground mines and chemical and petroleum processing facilities, can be quite vulnerable to fires, explosions and shocks. In such environments, uncontrolled flames, explosions or shocks can cause death, property loss and other serious damages. Thus, electronic equipment used in these environments are expected to meet what are known as intrinsically safe standards. These standards are intended to reduce the risk of electrical faults that may cause fires, explosions or shocks. Examples of intrinsically safe standards include the AS/NZS 60079 standard and the IEC 60079 standard.

These standards cover many areas relating to the design of intrinsically safe circuits, and the components used in such circuits. One specific topic covered by these standards relates to the clearance and segregation between conductive paths within the circuits, including the clearance and segregation between the main input and the DC output of any power supply providing power to the circuit. Achieving such clearance and segregation in power supplies involves physically separating the conductive paths within the power supply, and using isolation techniques, such as opto-couplers and transformers, to segregate the main input from the DC output.

One common component of any power supply, including those that meet the intrinsically safe standards, is a transformer used to step up or step down the input voltage to the power supply to meet designed output specifications. Conventional transformers that meet the intrinsically safe standards for clearance and segregation may use a split bobbin that provides an adequate thickness of insulation between the primary and secondary windings of the transformer. Use of a split bobbin requires the bobbin to meet the following requirements; 1.0 mm separation through solid insulation and 10.0 mm creepage distance. This means that the bobbin material thickness must be 1.0 mm thick and the central barrier must provide a creepage distance of 10.0 mm. As the ferrite in the split bobbin transformer is also considered a conductive path, the distance from the primary winding to the ferrite must also meet the intrinsically safe standards for clearance and segregation. However, using a spilt bobbin reduces the flux coupling between the primary and secondary windings leading to reduced transformer performance and efficiency, and thus reduced power supply performance and efficiency. Further, availability of a split bobbin with the necessary physical dimensions to meet the intrinsically safe standards for clearance and segregation is also difficult to source or may need to be fabricated, thus making such transformers more costly.

An alternative to using a split bobbin to meet the intrinsically safe standards for clearance and segregation, is to provide a transformer with a layer of solid insulation between the primary and secondary windings. According to the intrinsically safe standards for clearance and segregation such a solid layer must be a solidly bonded layer where the insulation material used to form the layer is bonded together. Simply applying layers of insulating tape as is done with conventional transformers does not meet the intrinsically safe standards for clearance and segregation. Fabricating such a bonded layer of insulation material requires additional processes. As a result, the cost of the transformer is higher.

Planar transformers may also be configured to meet the intrinsically safe standards for clearance and segregation. With planar transformers, spiral patterns are etched on a multi-layered printed circuit board to form the windings of the transformer around a ferrite planar core positioned on the printed circuit board. Etching patterns on a printed circuit board is costly and the flux coupling between the primary and secondary windings is less than ideal.

Using any of the above transformer configurations in circuits that are to meet the intrinsically safe standards for clearance and segregation often results in transformers that are not optimal for the designed application, and/or that are difficult and more costly to fabricate.

Switching power supplies are commonly used in many applications, including the hazardous environments noted above. Switching power supplies are preferred because they are much smaller and lighter that other power supplies, but provide the same output power. Switching power supplies are also capable of regulating the output voltage over a wide range of input voltages. For example, isolated 90 Vac to 250 Vac, and isolated 9 Vdc to 35 Vdc output switching power supplies are common in such environments. However, such switching power supplies incorporate transformer configurations like those described above to meet the intrinsically safe standards for clearance and segregation. As a result, current switching power supplies suffer from the same problems the transformers are burdened with. For example, their fabrication costs are higher and the efficiency of the power supplies is reduced by the reduced efficiency of the transformers.

### SUMMARY

The present disclosure provides intrinsically safe transformers that can be used in many hazardous environments, including, but not limited to, underground mining environments and chemical and petroleum processing environments. In one embodiment, an intrinsically safe transformer includes a core former having a core former cylinder, and a ferrite core assembly. The core former may be a vertical core former or a horizontal core former. The core assembly has a first winding wrapped around the core former cylinder, and a second winding wrapped around the first winding. Either the first or the second winding can be an insulated winding. A ferrite core is secured to the core former. In some instances, the first winding can be a primary winding and the second winding can be a secondary winding, and in other instances the second winding can be the primary winding and the first winding can be the secondary winding. As noted, either the first or second winding, or both, can be an insulated winding.

In another embodiment, an intrinsically safe transformer includes a core former having a core former cylinder, and a ferrite core assembly. The core former may be a vertical core former or a horizontal core former. In this embodiment, the core assembly has a first winding wrapped around the core former cylinder. A bias winding is then wrapped around the first winding, and an insulating layer is wrapped around the bias winding. An insulating layer may be positioned between the first winding and the bias winding. A second winding is then wrapped around the insulating layer. Either the first or the second winding can be an insulated winding. A ferrite core is secured to the core former. In some instances, the first winding can be a primary winding and the second winding can be a secondary winding, and in other instances the second winding can be the primary winding and the first winding can be the secondary winding. As noted, either the first or second winding, or both, can be an insulated winding. Thus, in one embodiment the first winding is the insulated winding, and in another embodiment the second winding is the insulated winding.

In another embodiment, an intrinsically safe transformer includes a core former having a core former cylinder, and a ferrite core assembly. The core former may be a vertical core former or a horizontal core former. In this embodiment, the core assembly has a first portion of a first winding is wrapped around the core former cylinder, and a first insulating layer wrapped around the first portion of the first winding. A bias winding is then wrapped around the first insulating layer, and a first shield is positioned around the bias winding. A second winding is wrapped around the first shield, and a second shield is positioned around the second winding. A second portion of the first winding is then wrapping around the second shield. Either the first or the second winding can be an insulated winding. A ferrite core is secured to the core former. In some instances, the first winding can be a primary winding and the second winding can be a secondary winding, and in other instances the second winding can be the primary winding and the first winding can be the secondary winding. As noted, either the first or second winding, or both, can be an insulated winding. Thus, in one embodiment the first winding is the insulated winding, and in another embodiment the second winding is the insulated winding.

### DESCRIPTION OF THE DRAWINGS

FIG. 1 is a front view of an exemplary embodiment of an intrinsically safe vertical transformer according to the present disclosure;

FIG. 2 is a bottom view of the transformer of FIG. 1;

FIG. 3 is a side view of the transformer of FIG. 1;

FIG. 4 is a cross-sectional view of the transformer of FIG. 3 along line A-A;

FIG. 5 is a front view of an exemplary embodiment of a portion of an intrinsically safe transformer according to the present disclosure, illustrating a vertical transformer housing, and a primary winding wrapped around a ferrite core;

FIG. 6 is a front view of an exemplary embodiment of an intrinsically safe transformer according to the present disclosure, illustrating a secondary winding wrapped over the primary winding of FIG. 5;

FIG. 7 is a front view of an exemplary embodiment of an intrinsically safe horizontal transformer according to the present disclosure;

FIG. 8 is a is a side view of the transformer of FIG. 7;

FIG. 9 is a partial cross-sectional view of the transformer of FIG. 8 along line B-B;

FIG. 10 is a perspective view of an exemplary embodiment of a core former of the transformer of FIG. 7;

FIG. 11 is a bottom perspective view of the transformer of FIG. 7;

FIG. 12 is a bottom plan view of a first embodiment of an intrinsically safe horizontal transformer at a first stage in a fabrication sequence;

FIG. 13 is a bottom plan view of a first embodiment of an intrinsically safe horizontal transformer at a second stage in a fabrication sequence;

FIG. 14 is a bottom plan view of a first embodiment of an intrinsically safe horizontal transformer at a third stage in a fabrication sequence;

FIG. 15 is a bottom plan view of a first embodiment of an intrinsically safe horizontal transformer at a fourth stage in a fabrication sequence;

FIG. 16 is a bottom plan view of a first embodiment of an intrinsically safe horizontal transformer at a fifth stage in a fabrication sequence;

FIG. 17 is a bottom plan view of a first embodiment of an intrinsically safe horizontal transformer at a sixth stage in a fabrication sequence;

FIG. 18 is a bottom plan view of a second embodiment of an intrinsically safe horizontal transformer at a first stage in a fabrication sequence;

FIG. 19 is a bottom plan view of a second embodiment of an intrinsically safe horizontal transformer at a second stage in a fabrication sequence;

FIG. 20 is a bottom plan view of a second embodiment of an intrinsically safe horizontal transformer at a third stage in a fabrication sequence;

FIG. 21 is a bottom plan view of a second embodiment of an intrinsically safe horizontal transformer at a fourth stage in a fabrication sequence;

FIG. 22 is a bottom plan view of a second embodiment of an intrinsically safe horizontal transformer at a fifth stage in a fabrication sequence;

FIG. 23 is a bottom plan view of a second embodiment of an intrinsically safe horizontal transformer at a sixth stage in a fabrication sequence;

FIG. 24 is a bottom plan view of a second embodiment of an intrinsically safe horizontal transformer at a seventh stage in a fabrication sequence;

FIG. 25 is a bottom plan view of a second embodiment of an intrinsically safe horizontal transformer at an eighth stage in a fabrication sequence;

FIG. 26 is a cross-sectional view of an exemplary embodiment of a stranded wire within an insulating jacket as a secondary winding for the intrinsically safe transformer according to the present disclosure;

FIG. 27 is a cross-sectional view of an exemplary embodiment of a solid wire within an insulating jacket as a secondary winding for the intrinsically safe transformer according to the present disclosure;

FIG. 28 is a cross-sectional view of an exemplary embodiment of a stranded wire within an insulating sleeve as a secondary winding for the intrinsically safe transformer according to the present disclosure;

FIG. 29 is a block diagram of an embodiment of an intrinsically safe linear power supply with the transformer of the present disclosure;

FIG. 30 is a block diagram of an embodiment of an intrinsically safe switch mode power supply with the transformer of the present disclosure;

FIG. 31 is a block diagram of another embodiment of an intrinsically safe switch mode power supply with the transformer of the present disclosure;

FIGS. 32A and 32B is a circuit diagram for an exemplary embodiment intrinsically safe switch mode power supply with the transformer of the present disclosure;

FIG. 33 is an enlarged view of the circuit diagram of FIG. 32B;

FIGS. 34A, 34B and 34C is a circuit diagram for another exemplary embodiment intrinsically safe switch mode power supply with the transformer of the present disclosure;

FIG. 35 is an exemplary embodiment of an intrinsically safe inductor used in the intrinsically safe switch mode power supply of the present disclosure;

FIG. 36 is an exemplary embodiment of a circuit to limit the voltage and current used in the intrinsically safe switch mode power supply of the present disclosure;

FIG. 37 is an exemplary embodiment of a current limiter circuit used in the intrinsically safe switch mode power supply of the present disclosure; and

FIG. 38 is an exemplary embodiment of an intrinsically safe inductor used in the intrinsically safe switch mode power supply of the present disclosure.

### DETAILED DESCRIPTION

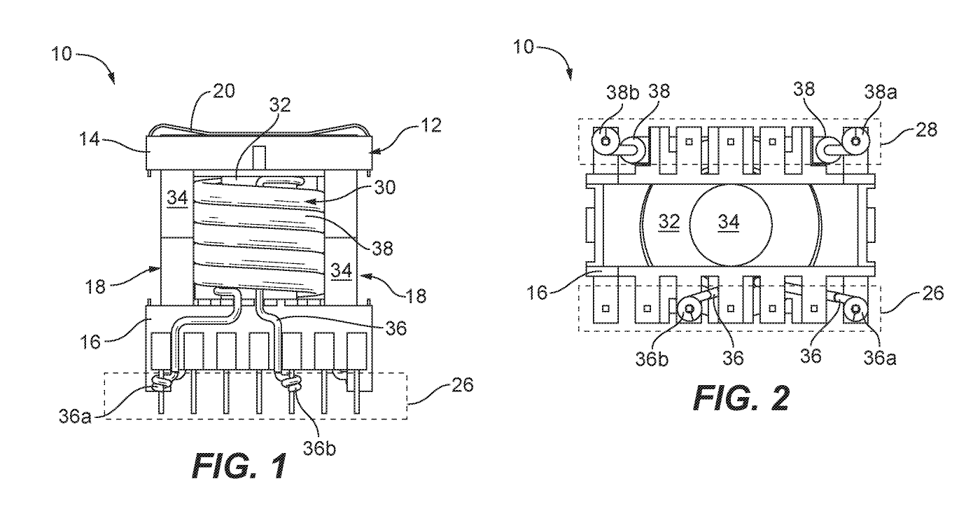

Referring to FIGS. 1-6, an embodiment of an intrinsically-safe vertical transformer 10 is shown.

FIG. 1 shows a front view of the transformer 10.

The transformer 10 includes a core former 12 and a core assembly 18. The core former 12 has a top 14, a base 16 and a cylinder 32 attached between the top 14 and the base 16. The base 16 has a pin set 26 and a pin set 28, where the pin set 26 is a row of pins on one side of the core former 12 and the pin set 28 is a row of pins on another side of the core former 12 (shown in FIG. 2).

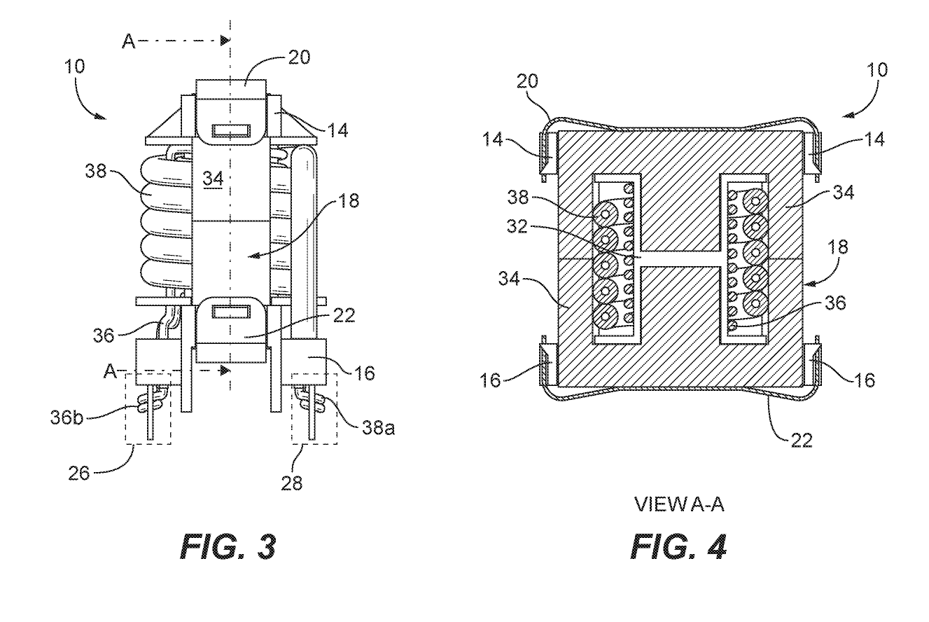

A ferrite core assembly 34 is mounted to the core former 12 and is secured at the top by a clip 20 and at the bottom by a clip 22 (shown in FIGS. 3 and 4). A primary winding 36 wrapped around the cylinder 32 enclosing, at least partially, the ferrite core assembly 34. A secondary winding 38 is wrapped around the primary winding 36.

In this embodiment, the primary winding 36 is made of traditional enameled transformer wire. The gauge of the primary winding is dependent upon the current rating for the transformer, which differs for different applications, as is known in the art. An end 36a of the primary winding 36 is attached to one pin in the pin set 26, and an end 36b of the primary winding 36 is attached to another pin in the pin set 26.

FIG. 2 shows a bottom view of the transformer 10.

The end 36a of the primary winding 36 is attached to one pin in the pin set 26, and the end 36b of the primary winding 36 is attached to another pin in the pin set 26.

An end 38a of the secondary winding 38 is attached to one pin in the pin set 28, and an end 38b of the secondary winding 38 is attached to another pin in the pin set 28.

The clip 22 attaches to the base 16 to secure it to the ferrite core assembly 34.

FIG. 3 shows a side view of the transformer 10 with a cross section reference A.

The clip 20 secures the top 14 of the core former 12 to the ferrite core assembly 34 to and the clip 22 secures the bottom 16 of the core former 12 to the ferrite core assembly 34.

The end 36a of the primary winding 36 is attached to a pin in the pin set 26, and the end 38b of the secondary winding 38 is attached to a pin in the pin set 28.

FIG. 4 shows a cross sectional view of the transformer 10 as indicated by the cross section reference A-A in FIG. 3.

The primary winding 36 is wrapped around the cylinder 32. The secondary winding 38 is wrapped around the primary winding 36. The clips 20 and 22 hold the top 14 and the bottom 16 of the ferrite core assembly 34 together.

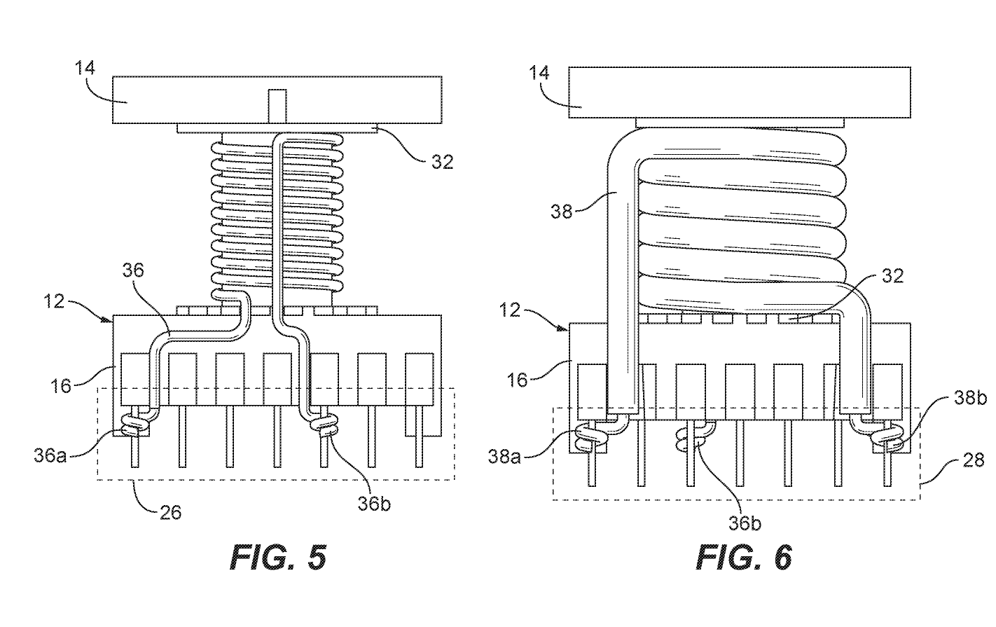

FIG. 5 shows a front view of an embodiment of a partially assembled intrinsically safe transformer 10.

The cylinder 32 is coupled to the top 14 and the bottom 16 of the transformer 10. An end 36a of the primary winding 36 is coupled to a pin in the set of pins 26. The primary winding 36 is wrapped around the cylinder 32 and the other end 36b of the primary winding 36 is coupled to another pin in the set of pins 26. The secondary winding 38 is not yet attached.

FIG. 6 shows a rear view of an embodiment of a partially assembled intrinsically safe transformer 10.

An end 38a of the secondary winding 38 is coupled to a pin in the set of pins 28. The secondary winding 38 is wrapped around the primary winding 36 and the other end 38b of the secondary winding 38 is coupled to another pin in the set of pins 28.

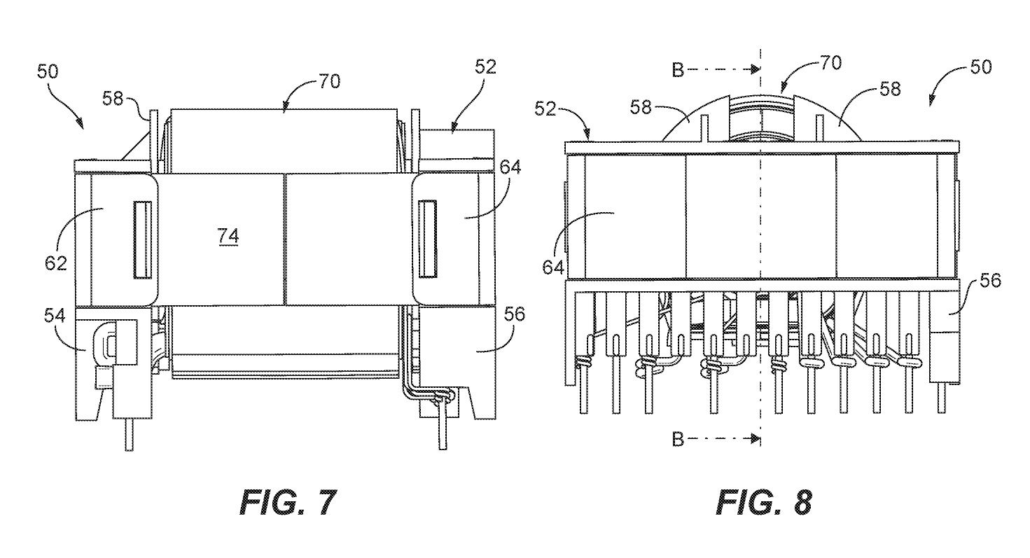

FIGS. 7-11 illustrate an intrinsically safe horizontal transformer 50.

FIG. 7 is a front view of an embodiment of an intrinsically safe horizontal transformer 50.

The transformer 50 includes a core former 52 and a ferrite core assembly 74. The core former 52 has a set of pins 54 and a set of pins 56 separated by a cylinder 58.

The ferrite core assembly 74 is mounted to the core former 52 and is secured with clips 62 and 64.

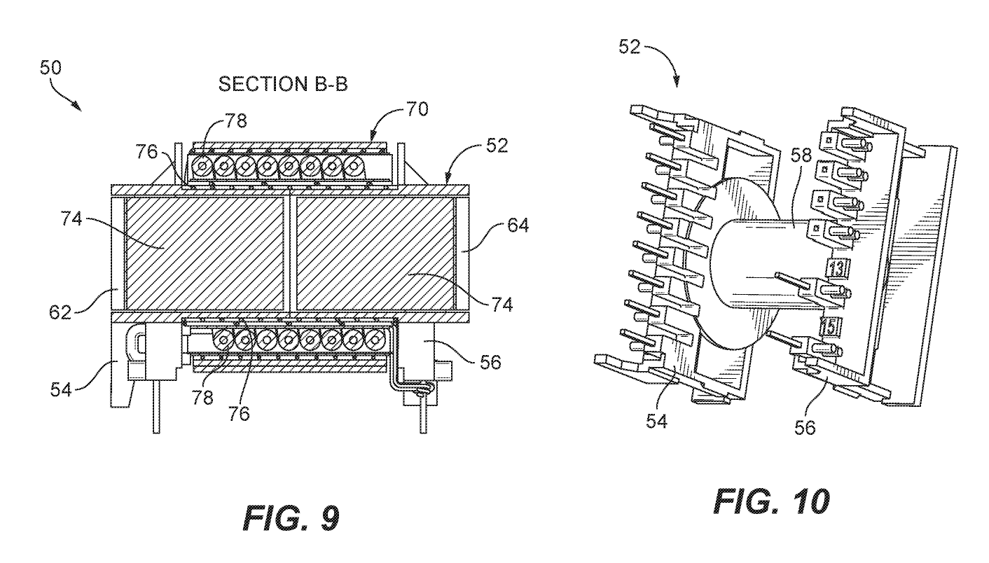

FIG. 8 is a side view of an embodiment of the intrinsically safe horizontal transformer 50 including a line B-B indicating the orientation of the cross-sectional view in FIG. 9.

FIG. 9 is a partial cross-sectional view of an embodiment of the intrinsically safe horizontal transformer 50.

A primary winding 76 wrapped around the core former cylinder 58, and a secondary winding 78 wrapped around the primary winding 76. In this embodiment, the primary winding 76 is made of traditional enameled transformer wire. The gauge of the primary winding is dependent upon the current rating for the transformer, which differs for different applications, as is known in the art.

FIG. 10 is a perspective view of an embodiment of the intrinsically safe horizontal transformer 50.

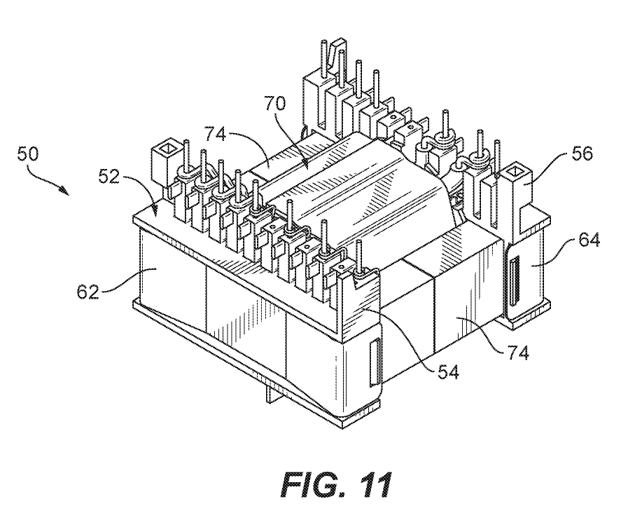

FIG. 11 is a bottom perspective view of an embodiment of the intrinsically safe horizontal transformer 50.

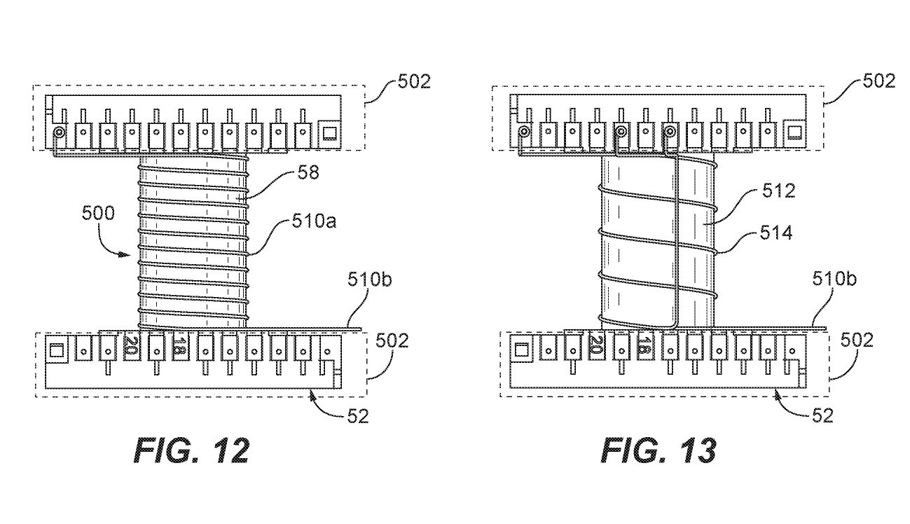

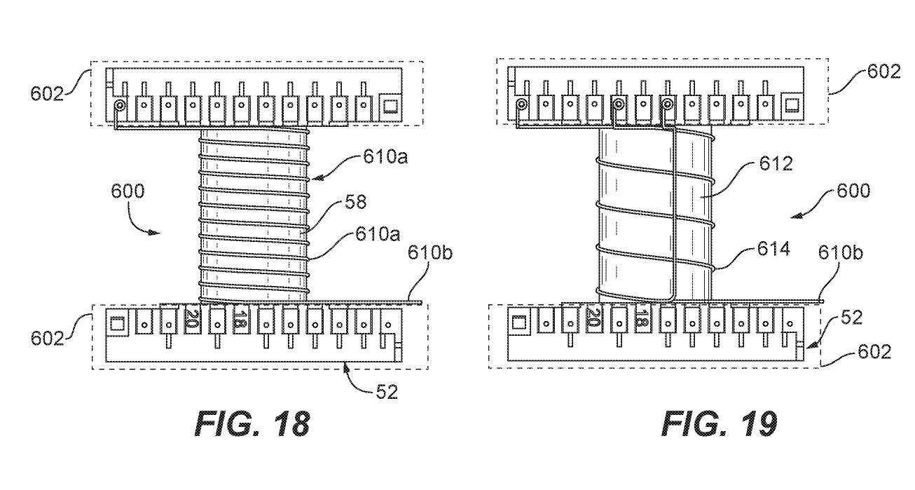

To further increase the efficiency of the transformers, other winding arrangements for the transformers may be implemented. For example, FIGS. 12-17 illustrate an exemplary embodiment of a sequence of fabrication of an intrinsically safe horizontal transformer that includes a bias winding. As another example, FIGS. 18-25 illustrate an exemplary embodiment of a sequence of fabrication of an intrinsically safe horizontal transformer that includes a bias winding and shields.

FIG. 12 is a side view of a first embodiment of an intrinsically safe horizontal transformer at a first stage in a fabrication sequence.

Starting with a transformer core former, such as core former 52 (shown in FIG. 10), a transformer assembly 500 having a first half 510a of a primary winding 510 has one end connected to a pin in the pin set 502 and is then wrapped around a core former cylinder, such as core former cylinder 58 of core former 52.

FIG. 13 is a side view of a first embodiment of an intrinsically safe horizontal transformer at a second stage in a fabrication sequence.

A layer of insulating tape 512 is wrapped over the first half 510a of the primary winding 510, and a bias winding 514 having one end connected to a pin in the pin set 502 is then wrapped around the insulating tape 512 and the other end is connected to a different pin in the pin set 502.

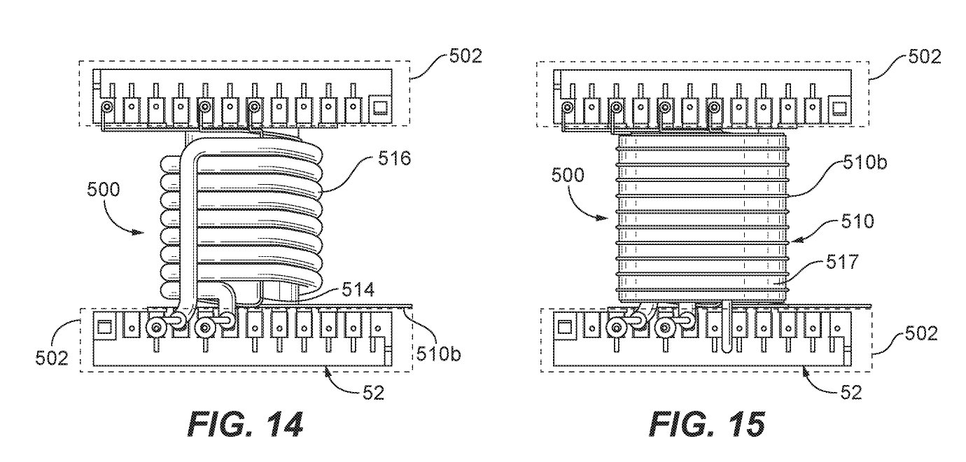

FIG. 14 is a side view of a first embodiment of an intrinsically safe horizontal transformer at a third stage in a fabrication sequence.

A secondary winding 516 having a stranded or solid wire core and an insulating jacket or sleeve as described herein, is wrapped around the bias winding 514, and the ends of the secondary winding are tied to pins in the pin set 502.

FIG. 15 is a side view of a first embodiment of an intrinsically safe horizontal transformer at a fourth stage in a fabrication sequence.

A layer of insulating tape 517 is wrapped over the secondary winding 516, and the second half 510b of the primary winding 510 is then wrapped around the layer of insulating tape 517, and the end is connected to a pin in the pin set 502.

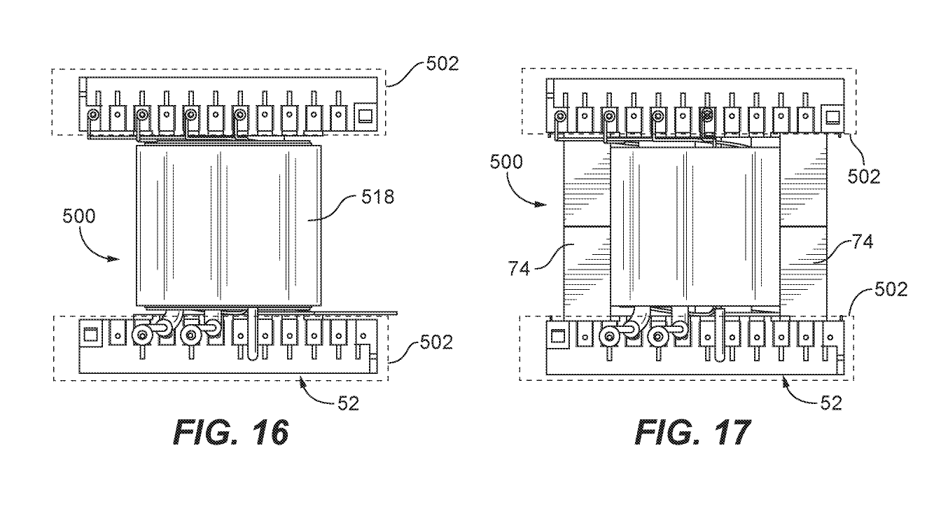

FIG. 16 is a bottom plan view of a first embodiment of an intrinsically safe horizontal transformer at a fifth stage in a fabrication sequence.

A layer of insulating tape 518 is wrapped around the second half 510b of the primary winding 510. Preferably, the layer of insulating tape 518 is 1 mm in thickness.

FIG. 17 is a bottom plan view of a first embodiment of an intrinsically safe horizontal transformer at a sixth stage in a fabrication sequence;

The ferrite cores 74 are added to the transformer assembly 500, and clips, similar to clips 62 and 64 (seen in FIG. 11), secure the ferrite core assembly to the core former 52.

FIG. 18 is a bottom plan view of a second embodiment of an intrinsically safe horizontal transformer at a first stage in a fabrication sequence.

Starting with a transformer core former, such as transformer core former 52 (shown in FIG. 10), a transformer assembly 600 having a first half 610a of a primary winding 610 has one end connected to a pin in the pin set 602, and is then wrapped around a core former cylinder, such as core former cylinder 58 of core former 52.

FIG. 19 is a bottom plan view of a second embodiment of an intrinsically safe horizontal transformer at a second stage in a fabrication sequence.

A layer of insulating tape 612 is then wrapped over the first half 610a of the primary winding 610, and a bias winding 614 having one end connected to a pin in the pin set 602 is then wrapped around the insulating tape 612 and the other end is connected to a different pin in the pin set 602.

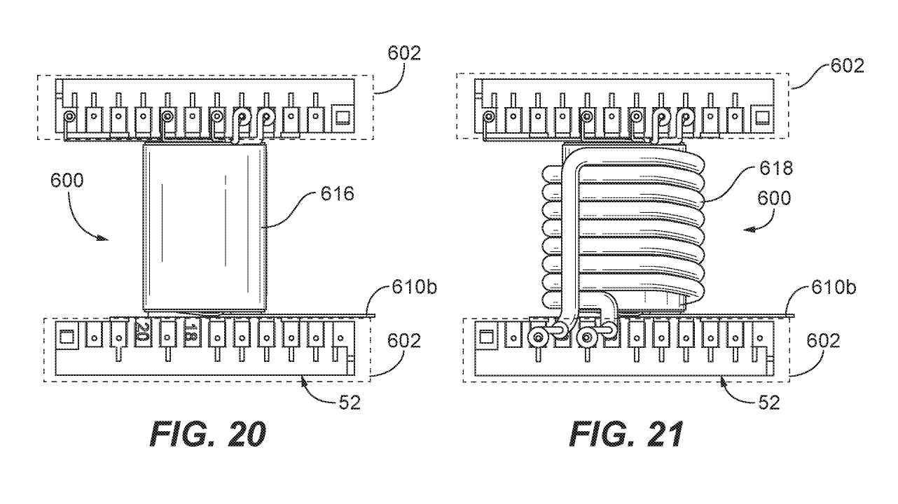

FIG. 20 is a bottom plan view of a second embodiment of an intrinsically safe horizontal transformer at a third stage in a fabrication sequence.

A first shield 616 having a wire soldered onto the shield 616 is positioned around the bias winding 614 and the shield wire is connected to a pin in the pin set 602.

FIG. 21 is a bottom plan view of a second embodiment of an intrinsically safe horizontal transformer at a fourth stage in a fabrication sequence.

A secondary winding 618 having a stranded or solid wire core and an insulating jacket or sleeve as described herein, is wrapped around the first shield 616, and the ends of the secondary winding are connected to pins in the pin set 602.

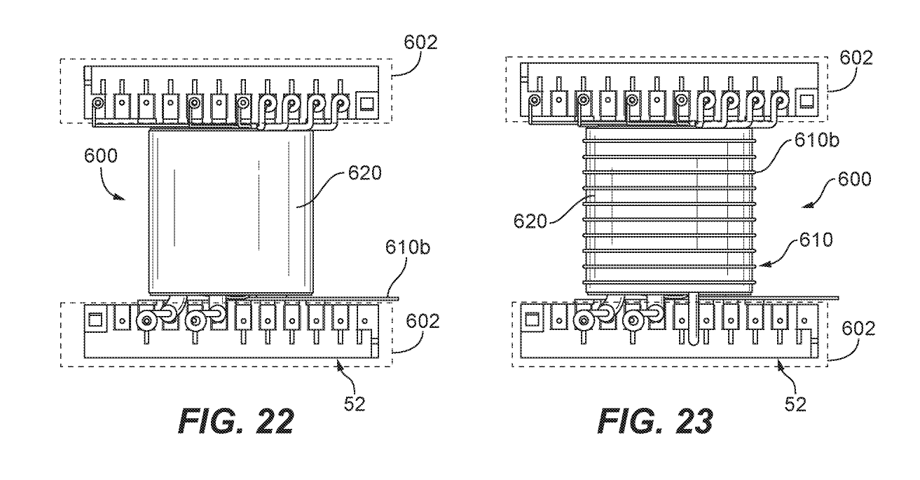

FIG. 22 is a bottom plan view of a second embodiment of an intrinsically safe horizontal transformer at a fifth stage in a fabrication sequence.

A second shield 620 having a wire soldered onto the shield 620 is positioned around the secondary winding 618 and the shield wire is connected to a pin in the pin set 602.

FIG. 23 is a bottom plan view of a second embodiment of an intrinsically safe horizontal transformer at a sixth stage in a fabrication sequence.

The second half 610b of the primary winding 610 is then wrapped around the second shield 620, and the end is connected to a pin in the pin set 602.

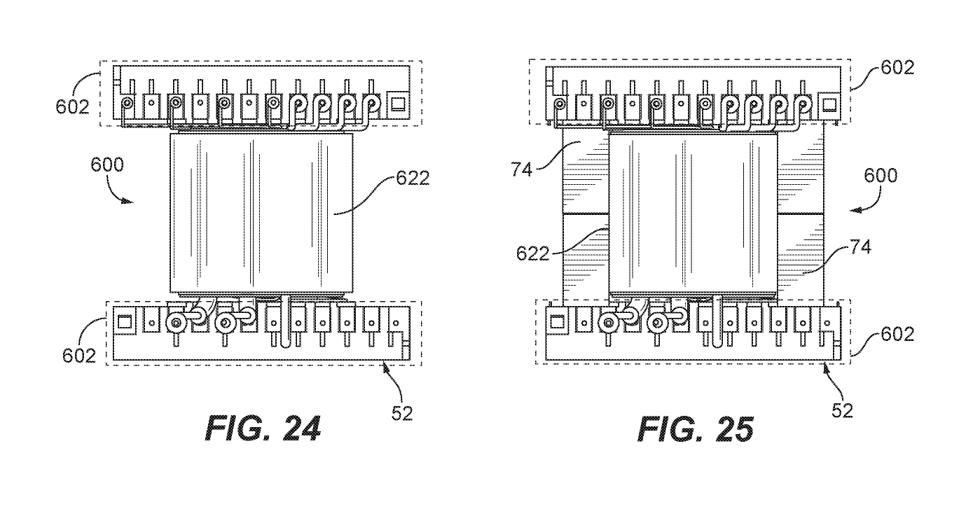

FIG. 24 is a bottom plan view of a second embodiment of an intrinsically safe horizontal transformer at a seventh stage in a fabrication sequence.

A layer of insulating tape 622 is then wrapped around the second half 610b of the primary winding 610. Preferably, the layer of insulating tape 622 is 1 mm in thickness.

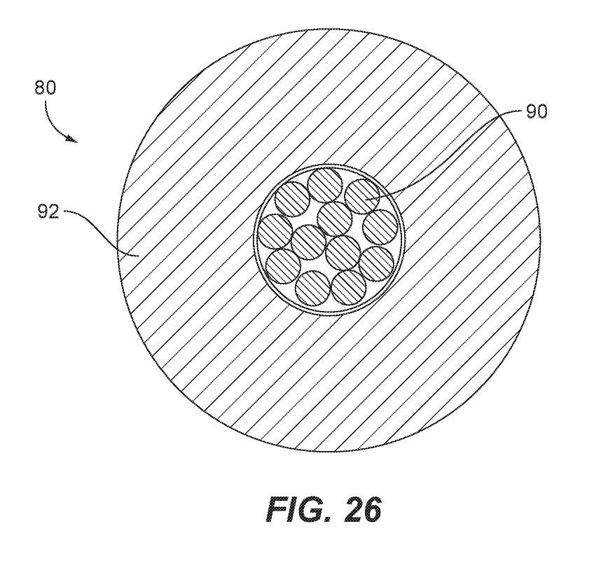

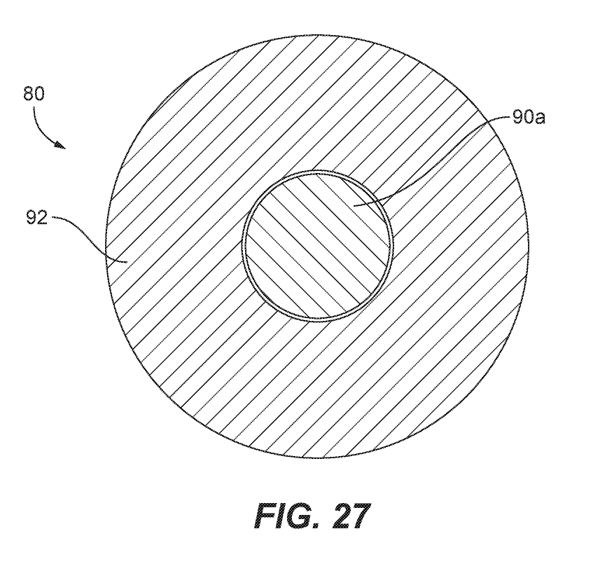

FIG. 25 is a bottom plan view of a second embodiment of an intrinsically safe horizontal transformer at an eighth stage in a fabrication sequence.

To complete the sequence, the ferrite cores 74 are added to the transformer assembly 600, and clips, similar to clips 62 and 64 (seen in FIG. 11), secure the ferrite core assembly to the core former 52.

FIG. 26 illustrates one embodiment the secondary winding (38, 78, 516 or 618), collectively referred to as secondary winding 80 for the transformer embodiments described herein, is made of stranded wire 90 wrapped by an insulation jacket 92.

FIG. 27 illustrates another embodiment of the secondary winding 80 is made of single solid wire 90a wrapped by an insulation jacket 92.

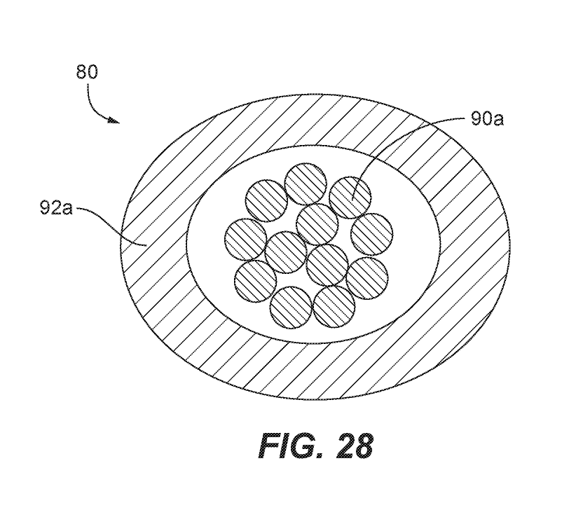

FIG. 28 shows another embodiment of the secondary winding 80 is made of stranded wire 90 (or a single solid wire 90a) within an insulation sleeve 92a.

The gauge of the stranded wire or solid wire forming the secondary winding 80, is dependent upon the current rating for the transformer, which differs for different applications, as is known in the art. The radial thickness of the insulation jacket 92 or the insulating sleeve 92a may be in the range of between about 0.8 mm and about 1.0 mm. Preferably, the radial thickness of the insulation jacket or sleeve is 1.0 mm. The insulation jacket or sleeve may be made of a thermo-plastic material, such as PVC or PE, or of a silicone based material, and is preferably made of a silicone to meet or exceed the temperature rating of the enameled primary winding.

It should be noted that in some embodiments the secondary winding is made of stranded wire which is more flexible than solid wire. Further, using stranded wire for the secondary winding in high frequency applications, such as switching mode power supplies, causes the effective current path to be on the outer layer of the wire strands. Having an effective current path on the outer layer of the wire strands, which is known as “skin effect,” improves the efficiency of the transformer due to less loss from the load side power.

As is known in the art, the total voltage induced into the secondary winding of a transformer is determined mainly by the ratio of the number of turns in the primary winding to the number of turns in the secondary winding (i.e., the turns ratio of the transformer), and by the amount of voltage applied to the primary winding. Thus, if the rated input voltage to the primary side of the transformer is known, and the rated output voltage from the secondary side of the transformer is known, the number of turns for the primary and secondary windings can be ascertained. In other words, a transformer would have a turns ratio between the primary winding and the secondary winding that is the ratio of the input and output voltage rating of the transformer (VpNs, where Vp is the primary voltage and Vs is the secondary voltage). For example, a 240 Vac to 12V ac rated step-down transformer would have a turns ratio of 20 (or 20:1), where there would be 20 turns on the primary winding to every 1 turn on the secondary winding. If the turns ratio is less than 1, such that the secondary voltage Vs is greater than the primary voltage Vp, then the transformer would be a step up transformer.

The transformer configurations described above provide a number of advantages. For example, as the insulation jacket or sleeve completely surrounds the wire strands or solid wire forming the secondary winding, the primary winding and secondary winding can be arranged in various configurations. For example, in the embodiment of FIGS. 1-6 the primary winding 36 is first wrapped around the ferrite core 34 and the secondary winding 38 is wrapped directly over the primary winding 36. As another example, in the embodiment of FIGS. 7-11 the primary winding 76 is first wrapped around the ferrite core 58 and the secondary winding 78 is wrapped directly over the primary winding 76. This can be achieved without the need for an insulation layer positioned between primary and secondary windings, and without the need for a split bobbin between the primary and secondary windings. As a result, the transformer of the present disclosure can be constructed using known techniques. Further, by placing the windings over each other, the flux coupling efficiency between the primary winding and the secondary winding exceeds the flux coupling efficiency in a split bobbin configuration. Further, as noted above, using stranded wire for the secondary winding in high frequency applications permits the skin effect to improve the flux coupling efficiency of the transformer.

In another configuration of the transformer windings, the efficiency between the primary and secondary windings can be further improved by using a bifilar winding technique. In the bifilar winding technique, the primary and secondary windings are twisted together before winding onto the former and wrapped around a ferrite core.

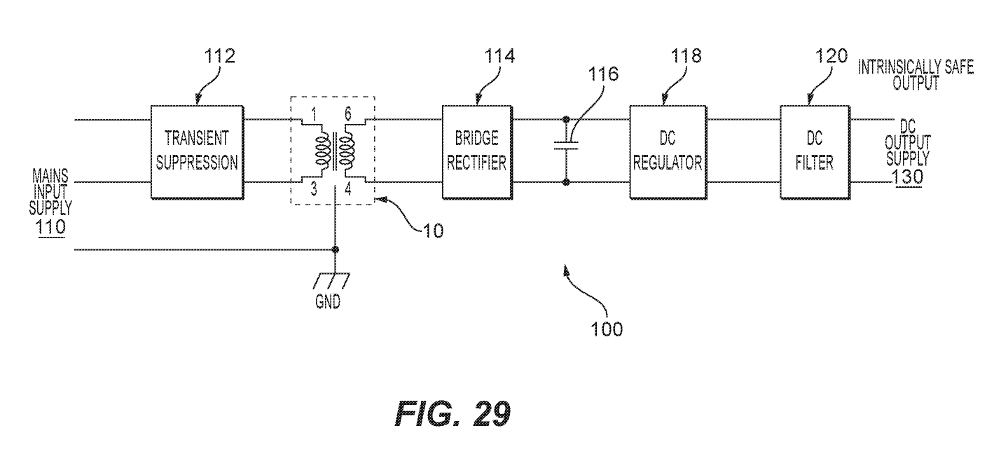

FIG. 29 illustrates an exemplary embodiment of a linear power supply 100 incorporating the transformer 10 (or 50).

In this embodiment, the mains input supply 110 first passes through a transient suppression circuit 112 configured to prevent spikes and transients from affecting the circuit. Transient suppression circuits are known in the art.

The transformer 10 provides a voltage transformation function by altering the output voltage of the transformer 10 according to the desired application. For example, a 120V input and 12VDC output may use a 10:1 turns ratio transformer.

The output of the transformer will be 12VAC which can then be rectified by the bridge rectifier circuit 114 and converted into a 12VDC level at capacitor 116, which removes spikes and transients on the output of the bridge rectifier circuit.

This 12VDC level can then be regulated to 12V by the DC regulator 118. Thus, the DC regulator circuit 118 regulates the DC voltage from the bridge rectifier circuit 114 to provide a required DC output voltage, which is then filtered by DC filter circuit 120 before being supplied as the DC output supply 130.

The bridge rectifier circuit 114, DC regulator circuit 118, and the DC filter circuit 120 may be implemented using known circuits in linear power supplies, or known circuits used in linear power supplies that meet the intrinsically safe standards for clearance and segregation. Using the transformer 10 of the present disclosure in such power supplies allows for the safe isolation of the mains input supply 110 from the DC output supply 130.

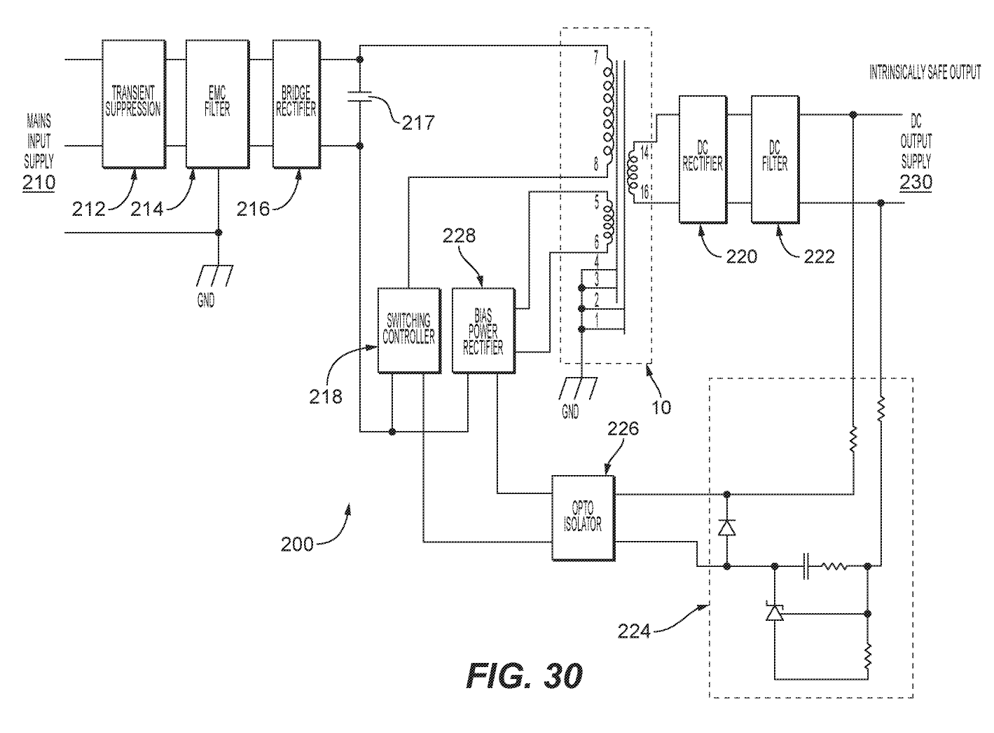

FIG. 30 illustrates an exemplary embodiment of a switch mode power supply 200 incorporating the transformer 10 (or 50).

In this embodiment, the mains input supply 210, which is an AC supply of for example 110 volts, 220 volts or 230 volts, passes through a transient suppression circuit 212 to prevent spikes and transients from affecting the circuit.

An EMC (or EMI) filter circuit 214 is used to suppress high voltage switching noise generated by the switch mode power supply 200 from passing back into the mains input supply 210.

The output of the EMC filter 214 passes through bridge rectifier circuit 216 and capacitor 217 to provide a high voltage DC output to the transformer 10. The transient suppression circuit 212, the EMC filter circuit 214 and the bridge rectifier circuit 216 may be implemented using known circuits in switching mode power supplies, or known circuits used in switching mode power supplies that meet the intrinsically safe standards for clearance and segregation.

The high voltage DC signal from the bridge rectifier circuit 216 is switched through the transformer 10 (or 50) by the switching controller circuit 218 at a high frequency. In some embodiments, the switching is at a frequency ranging between 66 kHz and 132 kHz. By varying the duty cycle of the switching to the transformer 10, the output voltage from the transformer can be controlled.

A DC regulator circuit 224 via an opto-coupler 226 to the switching controller 218 regulates the DC voltage from the transformer 10 to provide a desired DC output voltage, which is then filtered by DC filter circuit 222 before being supplied as the DC output supply 230. The opto-isolator circuit 226 is used to isolate the mains referenced side of the circuit from the isolated DC output. To control the output side of the opto-isolator 226, bias power from the bias windings of the transformer 10 and a bias power rectifier circuit 228 is fed to the opto-isolator 226. The output from the opto-isolator circuit 226 is used by the switching controller 218 to adjust the duty cycle and the output voltage of the transformer 10.

The DC regulator circuit 224 and the DC filter circuit 222 may be implemented using known circuits in switching mode power supplies, or known circuits used in switching mode power supplies that meet the intrinsically safe standards for clearance and segregation. Using the transformer 10 of the present disclosure in such power supplies allows for the safe isolation of the mains input supply 210 from the DC output supply 230.

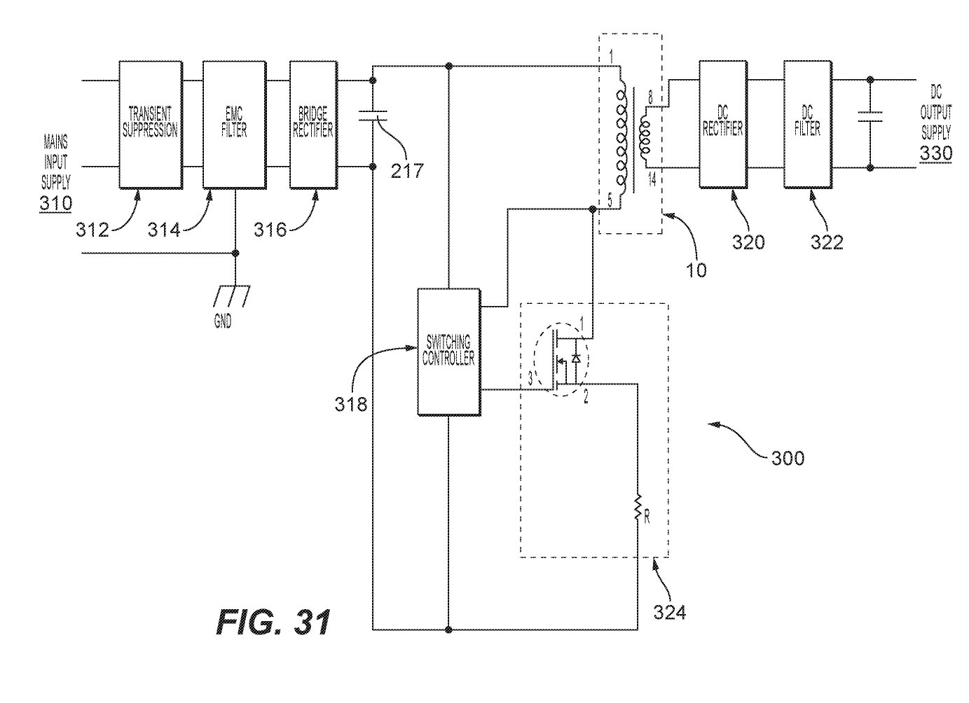

FIG. 31 illustrates an exemplary embodiment of another switch mode power supply 300 incorporating the transformer 10 (or 50).

In this embodiment, the mains input 310, either an AC supply or a DC supply, passes through a transient suppression circuit 312 to prevent spikes and transients from affecting the switch mode power supply 300.

An EMC filter circuit 314 is used to suppress the high voltage switching noise generated by the switch mode power supply 300 from passing back into the mains input supply.

The mains input supply voltage is then fed through a bridge rectifier circuit 316 to provide a high voltage DC output.

The high voltage DC from the bridge rectifier circuit 316 is switched through the transformer 10 by the switching controller circuit 318 at a high frequency. In some embodiments, the switching is at a frequency equal to or greater than 42 kHz.

By varying the duty cycle of the switching to the transformer 10, the output voltage of the transformer 10 can be controlled. A DC regulator circuit 320 rectifies the DC voltage from the transformer 10 to provide a desired DC output voltage, which is then filtered by DC filter circuit 322 before being supplied as the DC output supply 330.

The circuit 324 provides feedback using a primary winding inductive pulse. The switching controller 318 uses the voltage level of the primary winding inductive pulse to adjust the duty cycle and the output voltage of the transformer 10. The switching controller 318 uses the primary flyback voltage to determine the load on the power supply, using known boundary mode control techniques, which removes the need to provide isolation for the feedback circuits.

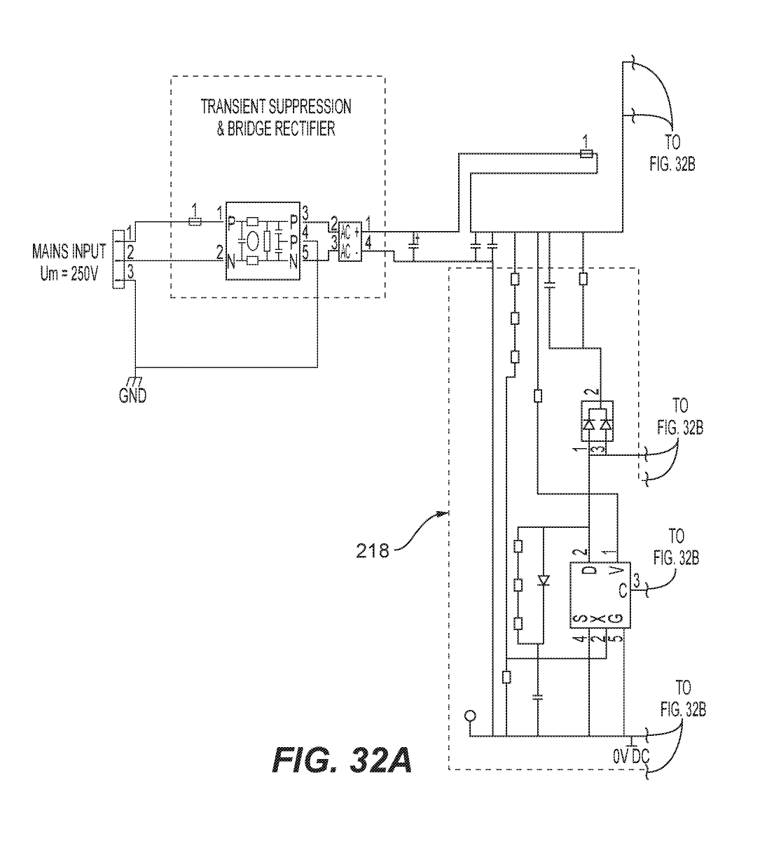

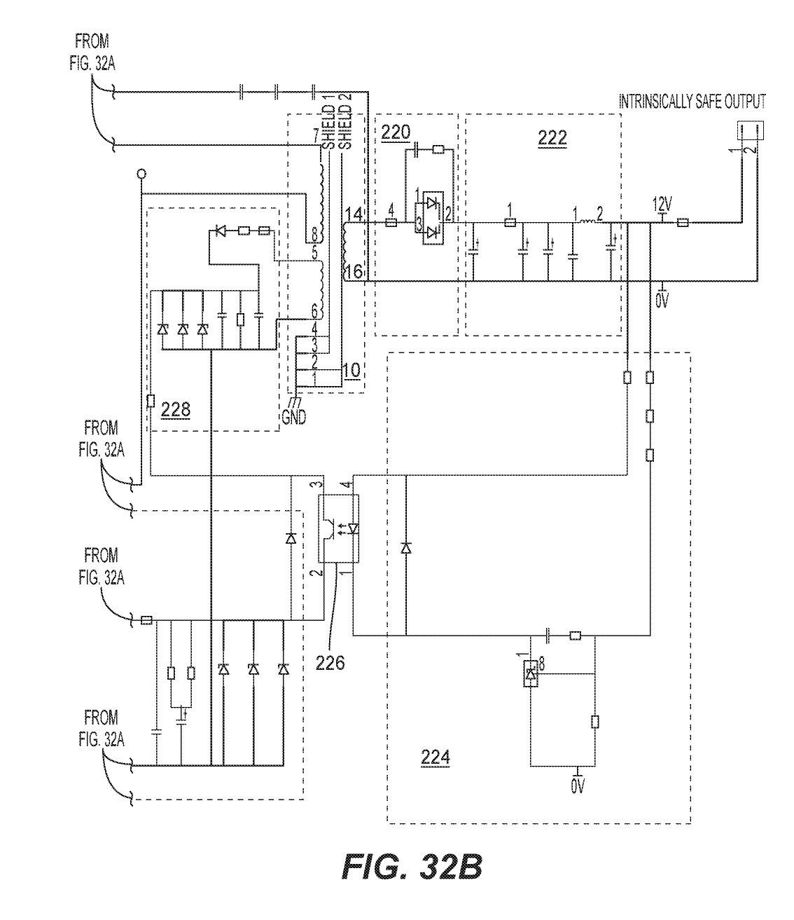

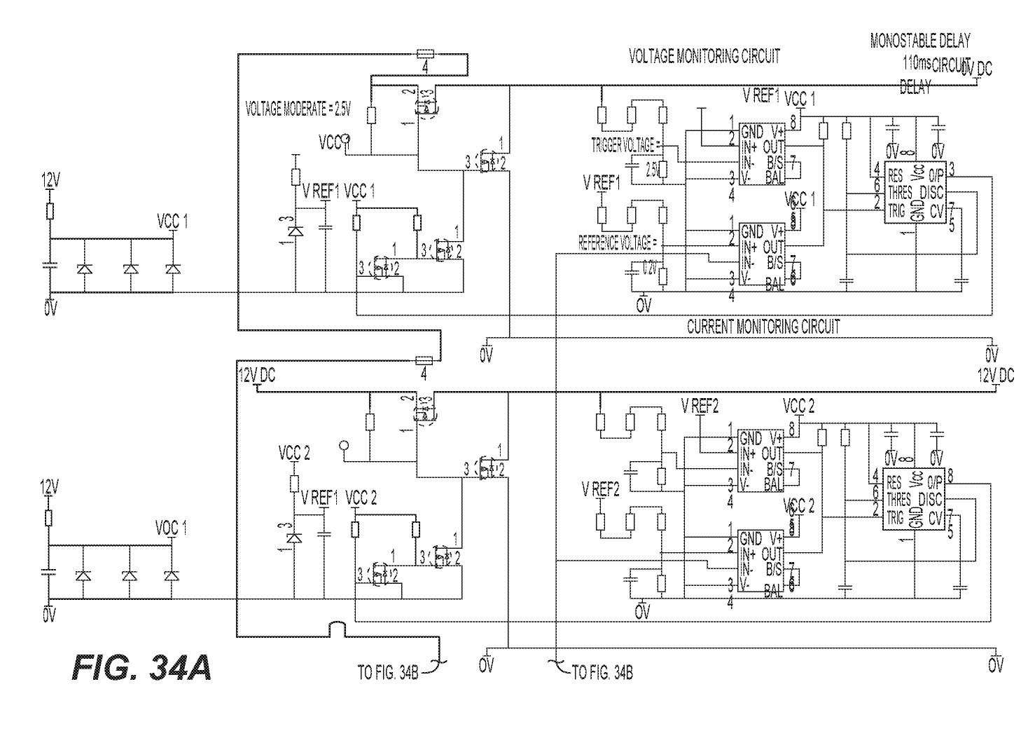

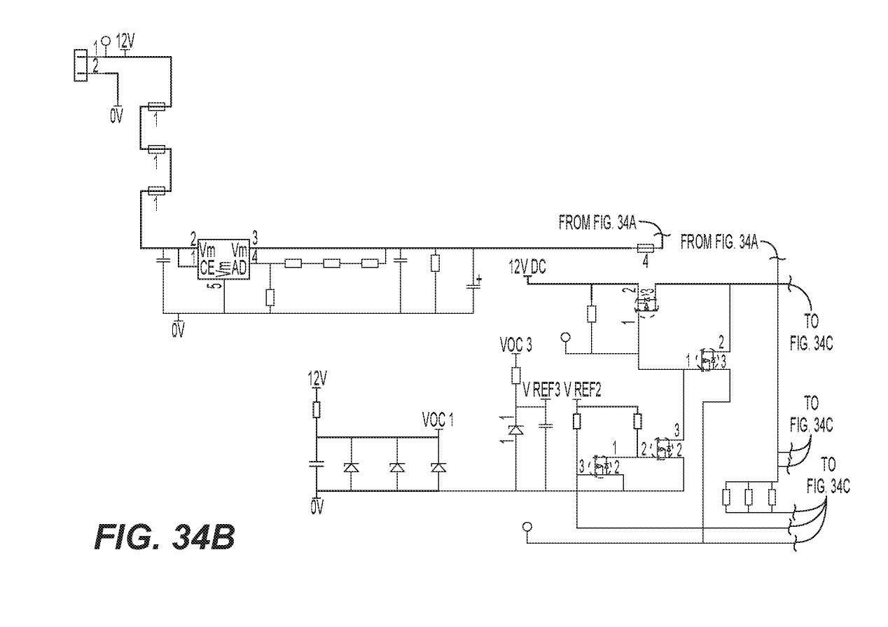

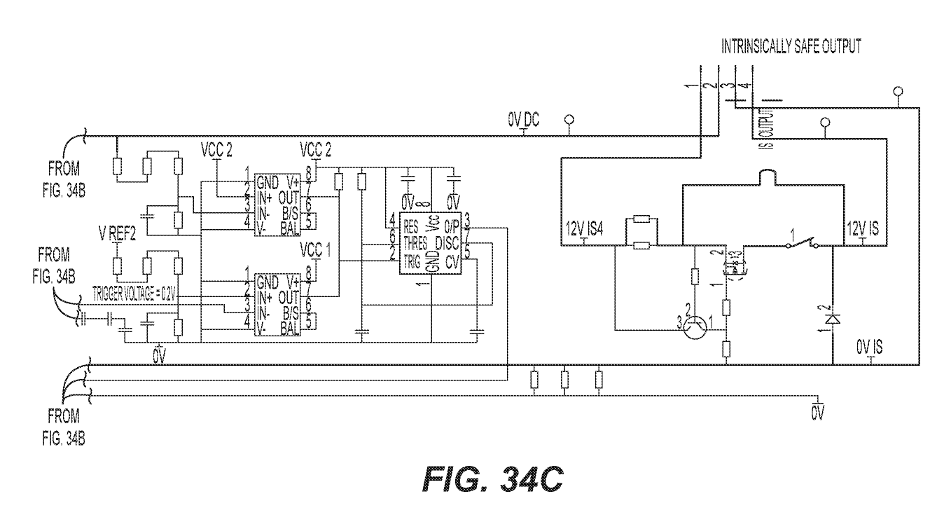

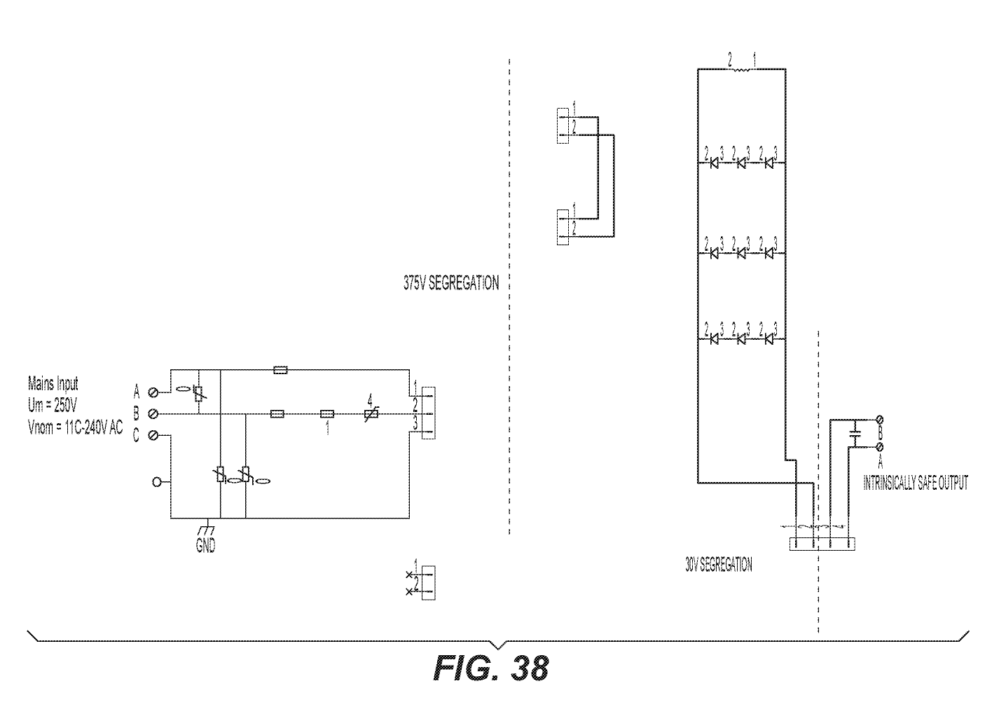

FIGS. 32A, 32B, 33, 34A, 34B, 34C and 35-38 are block diagrams of embodiments of circuits used in the intrinsically safe switch mode power supply with the transformer of the present disclosure.

The figures are drawn from a conventional switching power supply topology, but include intrinsically safe features. From an intrinsically safety point of view the main changes to a conventional switching power supply topology include:

An intrinsically safe transformer 10 according to the present disclosure is used in place of a conventional transformer. This intrinsically safe transformer 10 has physical separation between the windings and is disclosed in the main body of the present disclosure.

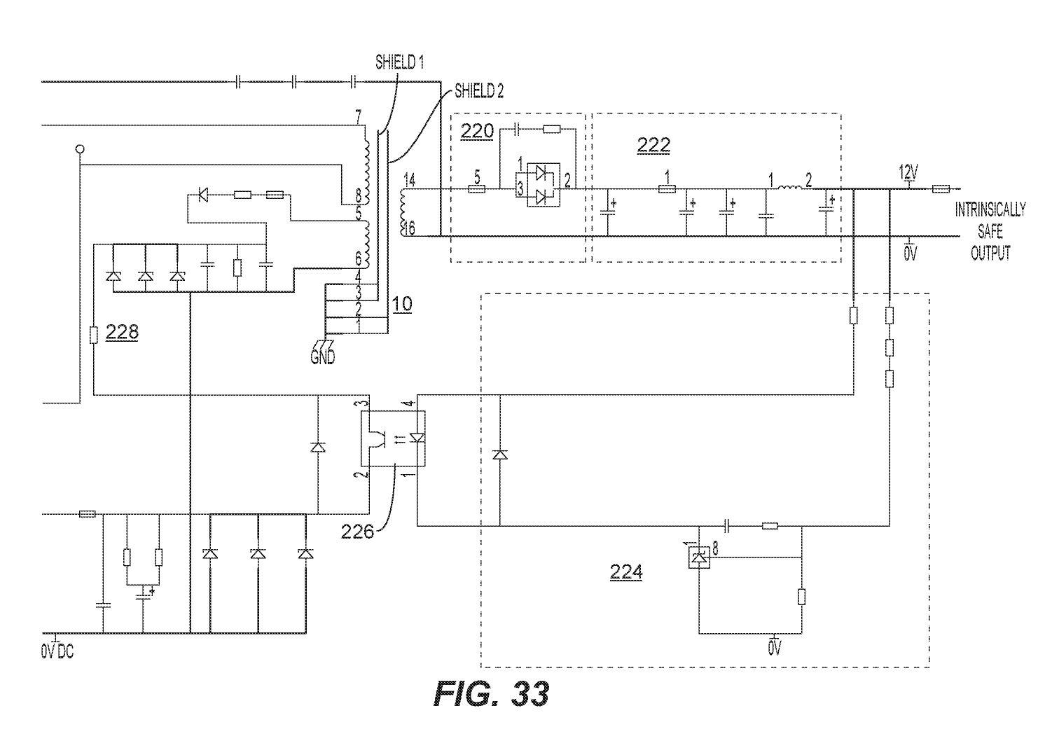

FIGS. 32A and 32B show one embodiment of intrinsically safe switch mode power supply with the transformer of the present disclosure and FIG. 33 shows an enlarged version of a portion of FIG. 33. The feedback to the switching controller 218 includes an opto-coupler (OC200) 226 and the integrity of the opto-coupler 226 is maintained according to the standards. To maintain the integrity of the opto-coupler 226, voltage limiting zener diodes are used around the mains side of the opto-coupler 226 as well as fuses and resistors to limit the power to the opto-coupler 226. The secondary side of the opto-coupler 226 is also protected by a set of resistors, and output voltage of the switching power supply.

The intrinsically safe output of the power supply of the present disclosure provides good load regulation and well defined voltage and current limiters. Intrinsically safe power supplies typically use active components to limit the voltage and current which improves their load regulation.

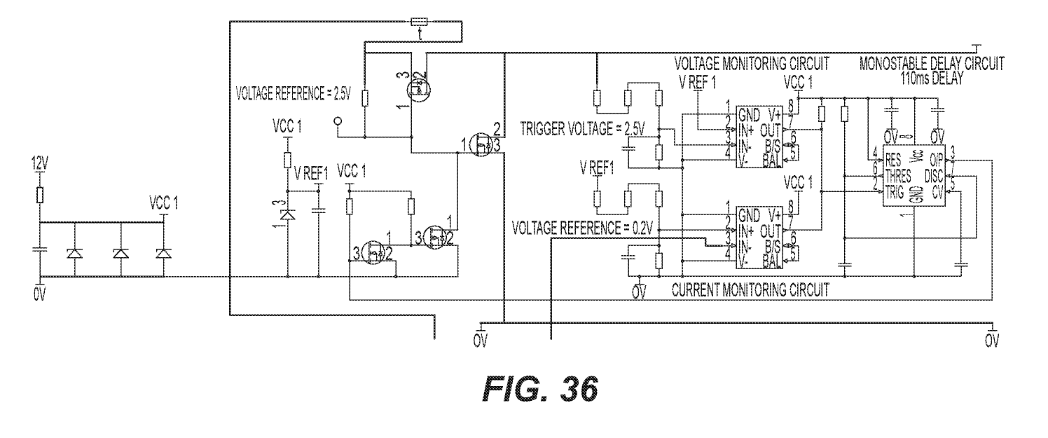

The intrinsically safe standards also specify the use of redundant circuits to ensure the safe operation of the power supply should one or more circuits fail. Thus, the power supply circuits according the present disclosure may include redundant circuits. For example, the main circuit to limit the voltage and current is a shunt MOSFET, seen in FIG. 36. A shunt MOSFET design meets the intrinsically safe standards, and is controlled by a redundant voltage and current sensing circuit. If the voltage or current exceeds the limits, the shunt MOSFET is activated which places a short circuit on the output lines. This effectively clamps the output line so that the voltage is reduced to a small value and shunts the current so that the output current is low. This has the advantage of also shunting any energy outside the circuit on the line, which reduces the effect of external capacitances and inductances. A series MOSFET may be used to disconnect the switching power supply from the circuit to protect the fuse from failing as well as limiting the current into the shunt MOSFETS.

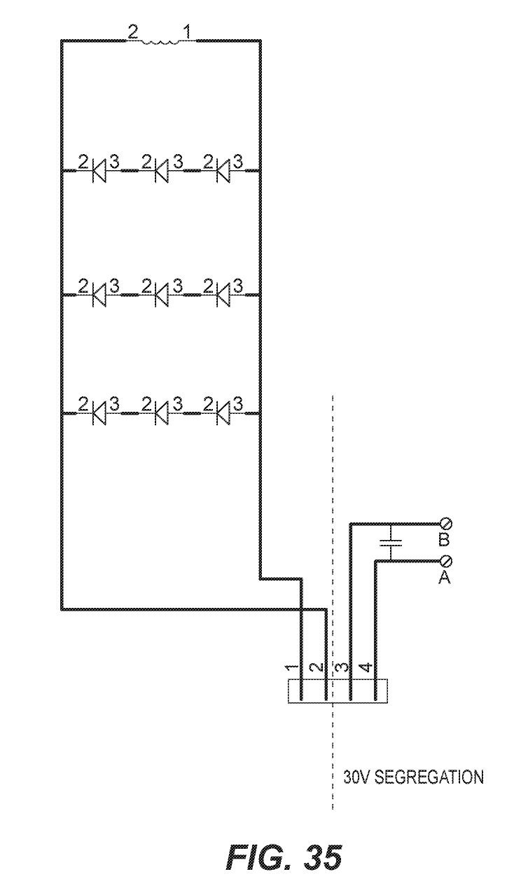

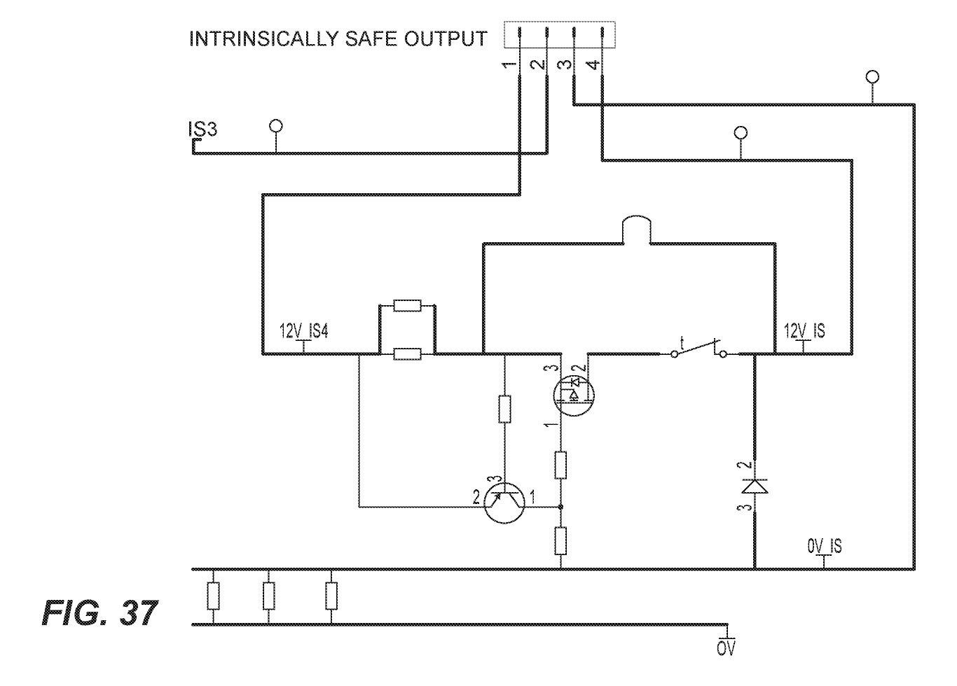

A delay circuit allows the shunt circuit to be reset after an event. A current limiter circuit (seen in FIG. 37) may also be used to improve the in-rush current capability should a large capacitive load be connected to the power supply. The output voltage of the power supply passes through an intrinsically safe inductor (seen in FIG. 35), which provides further control by limiting the slew rate of the output current. This slows down the current change which improves the sense circuit response.

As noted, the various embodiments of the transformer assemblies, including the various embodiments of the secondary windings, and the winding sequence can be interchanged without departing from the scope of the present disclosure. The present disclosure also contemplates having a primary winding with an insulating jacket or sleeve and the secondary winding as a standard enameled wire without insulation. Further, while the drawings show the primary winding wrapped around the ferrite core, and then the secondary winding wrapped around the primary winding, the present disclosure fully contemplates embodiments where the secondary winding is wrapped around the ferrite core and then the primary winding is wrapped around the secondary winding. The transformer configurations described herein can be used in any of the power supply circuit embodiments disclosed herein or in any other power supply or circuits to be used in intrinsically safe environments, such as in signal transformers. Further, it will be understood that various modifications can be made to the embodiments of the present disclosure herein without departing from the spirit and scope thereof. Therefore, the above description should not be construed as limiting the disclosure, but merely as embodiments thereof. Those skilled in the art will envision other modifications within the scope and spirit of the invention as defined by the claims appended hereto.

What is claimed is:

1. An intrinsically safe transformer, comprising:
a core former having a core former cylinder; and
a ferrite core assembly having a first winding wrapped around the core former cylinder, a second winding wrapped around the first winding, wherein the first or the second winding is an insulated winding, and a ferrite core secured to the core former.

2. The transformer according to claim 1, wherein the first winding is a primary winding and the second winding is a secondary winding.

3. The transformer according to claim 2, wherein the second winding is the insulated winding.

4. The transformer according to claim 2, wherein the first winding is the insulated winding.

5. The transformer according to claim 1, wherein the first winding is a secondary winding and the second winding is a primary winding.

6. The transformer according to claim 5, wherein the first winding is the insulated winding.

7. The transformer according to claim 5, wherein the second winding is the insulated winding.

8. The transformer according to claim 1, wherein the core former is a vertical core former.

9. The transformer according to claim 1, wherein the core former is a horizontal core former.

10. An intrinsically safe transformer, comprising:
a core former having a core former cylinder; and
a ferrite core assembly having a first winding wrapped around the core former cylinder, a bias winding wrapped around the first winding, an insulating layer wrapped around the bias winding, a second winding wrapped around the insulating layer, wherein the first or the second winding is an insulated winding, and a ferrite core secured to the core former.

11. The transformer according to claim 10, wherein the first winding is a primary winding and the second winding is a secondary winding.

12. The transformer according to claim 11, wherein the second winding is the insulated winding.

13. The transformer according to claim 11, wherein the first winding is the insulated winding.

14. The transformer according to claim 10, wherein the first winding is a secondary winding and the second winding is a primary winding.

15. The transformer according to claim 14, wherein the first winding is the insulated winding.

16. The transformer according to claim 14, wherein the second winding is the insulated winding.

17. The transformer according to claim 10, wherein the core former is a horizontal core former.

18. The transformer according to claim 10, wherein an insulating layer is between the first winding and the bias winding.

19.

20. An intrinsically safe transformer, comprising:
a core former having a core former cylinder; and
a ferrite core assembly having a first portion of a first winding wrapped around the core former cylinder, a first insulating layer wrapped around the first portion of the first winding, a bias winding wrapped around the first insulating layer, a first shield positioned around the bias winding, a second winding wrapped around the first shield, a second shield positioned around second winding, wrapping a second portion of the first winding around the second shield, wherein the first or the second winding is an insulated winding, and a ferrite core secured to the core former.

21. The transformer according to claim 20, wherein the first winding is a primary winding and the second winding is a secondary winding.

22. The transformer according to claim 21, wherein the second winding is the insulated winding.

23. The transformer according to claim 21, wherein the first winding is the insulated winding.

24. The transformer according to claim 20, wherein the first winding is a secondary winding and the second winding is a primary winding.

25. The transformer according to claim 24, wherein the first winding is the insulated winding.

26. The transformer according to claim 24, wherein the second winding is the insulated winding.

27. The transformer according to claim 20, wherein the core former is a horizontal core former.
